(19) United States
(12) Patent Application Publication
(10) Pub. No.: US 2008/0145569 A1
(43) Pub. Date: Jun. 19, 2008

(54) Method and Device For Hot-Dip Coating a Metal Strip

(76) Inventors: Holger Behrens, Erkrath (DE); Rolf Brisberger, Spielberg (AT); Hans-Georg Hartung, Pulheim (DE); Bodo Falkenhahn, Ratingen (DE)

Correspondence Address: FRIEDRICH KUEFFNER, 317 MADISON AVENUE, SUITE 910, NEW YORK, NY, 10017, US

(21) Appl. No.: 11/884,416

(22) PCT Filed: Jun. 30, 2006
(86) PCT No.: PCT/EP2006/006350

§ 371 Date: Dec. 3, 2007

(30) Foreign Application Priority Data
Jul. 1, 2005 (DE) 10 2005 030 772.8
Jul. 16, 2005 (DE) 10 2005 033 288.9

(51) Int. Cl. B05D 1/18; B05C 3/02

(52) U.S. Cl. 427/595; 118/620; 118/712

(57) ABSTRACT

The invention relates to a method for hot-dip coating a metal strip (1), particularly a steel strip, in which the metal strip (1) is fed to a receptacle (5) accommodating the melted coating metal (4) through a hole (6) in the bottom area of the receptacle (5) after passing through a furnace (2) and a roll chamber (3) that adjoins the furnace (2) in the direction of travel (F) of the metal strip (1). An electromagnetic field is generated in the bottom area of the receptacle (5) so as to retain the coating metal (4) in the receptacle (5). In order to obtain more advantageous operating conditions especially in case the performance of the hot-dip coating system drops, different gas atmospheres are maintained in at least two separate spaces (7, 8) of the roll chamber (3). The invention further relates to a hot-dip coating device.

The invention concerns a method for hot dip coating a metal strip, especially a steel strip, in which the metal strip is fed through a furnace and a roller chamber, which follows the furnace in the direction of conveyance of the metal strip, and into a tank that holds the molten coating metal through an opening in the bottom of the tank, where an electromagnetic field is generated near the bottom of the tank to retain the coating metal in the tank. The invention also concerns a device for hot dip coating.

Conventional metal hot dip coating installations for metal strip, as disclosed, for example, in EP 0 172 681 B1, have a high-maintenance component, namely, the coating tank and the fittings it contains. Before being coated, the surfaces of the metal strip must be cleaned of oxide residues and activated for bonding with the coating metal. For this reason, the strip surfaces are subjected to heat treatment processes in a reducing atmosphere before the coating operation is carried out. Since the oxide coatings are first removed by chemical or abrasive methods, the reducing heat treatment process activates the surfaces, so that after the heat treatment, they are present in a pure metallic state.

However, this activation of the strip surfaces increases their affinity for the surrounding atmospheric oxygen. To prevent the surface of the strip from being reexposed to atmospheric oxygen before the coating process, the strip is introduced into the hot dip coating bath from above in an immersion snout. Since the coating metal is present in the molten state, and since one would like to utilize gravity together with blowing devices to adjust the coating thickness, but the subsequent processes prohibit strip contact until the coating metal has completely solidified, the strip must be deflected in the vertical direction in the coating tank. This is accomplished with a roller that runs in the molten metal. This roller is subject to strong wear by the molten coating metal and is the cause of shutdowns and thus loss of production.

To prevent oxidation of the metal strip that has been prepared for hot dip coating, in the aforementioned conventional procedure, the steel strip enters the furnace through a brush seal and leaves the furnace by immersion in the coating tank. The furnace snout is also immersed in the molten metal to provide a seal from the atmospheric oxygen.

To prevent or suppress the evaporation of zinc during hot dip coating using the aforementioned conventional technology with a deflecting roller, WO 2004/003250 A1 proposes that a gas or gas mixture be present above the metal bath as an isolating gas, which has poor thermal conductivity and the property of being capable of reducing or eliminating turbulence of the gas or gas mixture above the surface of the metal bath.

To avoid the problems associated with rollers running in the molten coating metal, approaches have been proposed, in which a coating tank is used that is open at the bottom and has a guide channel for guiding the strip vertically upward, and in which an electromagnetic seal is used to seal the open bottom of the coating tank. The electromagnetic seal is produced by electromagnetic inductors, which operate with electromagnetic alternating or traveling fields that seal the coating tank at the bottom by means of a repelling, pumping or constricting effect. A solution of this type is described, for example, in EP 0 673 444 B1, WO 96/03533, and JP 50-86446.

In this well-known technology, which is also known as the CVGL process (CVGL=continuous vertical galvanizing line), the installation comprises essentially three main components, namely, the coating tank, the electromagnetic seal, and the roller chamber, in which the strip is deflected into the vertical direction. The roller chamber deflects the hot steel strip coming from the annealing furnace into the vertical and guides it further in the vertical direction to the connecting channel and the coating tank. The coating tank is connected with the furnace by a channel zone and the roller chamber.

EP 0 630 421 B1 discloses a solution of this type. The mechanical properties and the surface conditions for coating the strip with molten metal are adjusted in the annealing process that takes place in the furnace. Depending on the desired material properties, the steel strip is annealed under a protective gas atmosphere and is then brought to coating temperature, which is above 500° C. in the case of galvanizing. The protective gas atmospheres used for this purpose are composed mainly of nitrogen and hydrogen.

Details on the atmosphere that is used may be found in JP 06-145937 A and JP 03-056654 A.

In hot strip hot dip refining, the annealing treatment is eliminated. The steel strip is brought directly to the coating temperature of 460° C. to 700° C., depending on the coating medium.

If relatively large quantities of oxygen are present in the furnace, the surface of the annealed steel strip, which is hot before the coating process, oxidizes, and the molten metal does not adhere to the strip or adheres to only a limited extent. Adhesion problems arise, which reduce the quality of the coated steel strip.

In the aforesaid CVGL process, the system itself makes it impossible to seal the protective gas atmosphere from the environment by immersing the furnace snout in the metal, since before the start of the coating process, the region of the furnace above the roller chamber and the coating tank is open. After the molten metal has been introduced and the coating process has started, this region is then sealed by the medium.

Before the start of the coating process, the furnace atmosphere is adjusted in conformity with the starting conditions. In this connection, it is especially important to ensure a low oxygen content in the furnace. This is accomplished by flushing the furnace with nitrogen.

Although before the start of operation in the CVGL process, the furnace is open via the opening in the bottom of the coating tank, the protective gas atmosphere of the annealing furnace must not be subjected to an overall adverse effect by the entrance of atmospheric oxygen.

During the operation of the CVGL process, i.e., in the sealed state, the furnace atmosphere is present everywhere in the roller chamber in the prior-art solutions. Depending on the process adjustment, this atmosphere consists of nitrogen and hydrogen (in concentrations greater than or equal to 5 vol. %).

This can result in disadvantages, especially in the event of loss of power at the installation or in the event of an accident. In this case, specifically, atmospheric oxygen penetrates through the open channel zone into the roller chamber, which can cause problems due to the relatively high concentration of hydrogen.

Therefore, the objective of the invention is to create a method and a corresponding device for hot dip coating a metal strip, with which it is possible to overcome the specified disadvantages. Accordingly, we wish to ensure that even in the event of irregularities in the process sequence, an unfavorable gas composition does not occur in the installation.

In accordance with the invention, this objective is achieved by maintaining different gas atmospheres in at least two separated spaces of the roller chamber through which the metal strip passes.

In this connection, it is provided, in particular, that the gas atmosphere of a space of the roller chamber that is downstream in the direction of conveyance of the metal strip has a lower hydrogen concentration than the gas atmosphere of another space of the roller chamber that is upstream of this space.

The first space of the roller chamber in the direction of conveyance of the metal strip preferably has a gas atmosphere with a hydrogen concentration of greater than 5 vol. %, and especially greater than 7 vol. %.

By contrast, the last space of the roller chamber in the direction of conveyance of the metal strip preferably has a gas atmosphere with a hydrogen concentration of less than 5 vol. % and especially less than 3 vol. %.

It is preferred that, besides hydrogen, the gas atmospheres in the spaces of the roller chamber contain essentially only nitrogen, apart from unavoidable gaseous impurities and other unavoidable gaseous elements.

To allow an operation that is as stable as possible, it is preferably provided that the desired compositions of the gas atmospheres in the spaces of the roller chamber be maintained by a closed-loop control system.

The device for hot dip coating a metal strip has a furnace, a roller chamber downstream of the furnace in the direction of conveyance of the metal strip, and a tank for holding the molten coating metal, wherein the bottom of the tank has an opening, through which the metal strip is fed into the tank, and wherein an electromagnetic inductor for retaining the coating metal in the tank is located near the bottom of the tank.

In accordance with the invention, it is provided that at least one partition is present in the roller chamber, so that the roller chamber is divided into at least two spaces.

In this connection, each space of the roller chamber preferably has at least one gas supply line, through which gas of a well-defined type and/or composition can be introduced into the space. In addition, it can be provided that each space of the roller chamber has at least one gas sensor, with which the type and/or composition and/or concentration of a gas in the space can be determined.

Furthermore, an automatic control unit is preferably present, with which the gas composition and/or the concentration of a gas can be maintained at the desired values in at least one of the spaces and preferably in all of the spaces.

The roller chamber is preferably provided with a ceramic inner lining, which makes it easier to keep the chamber clean. The roller chamber preferably has a steel housing. However, it can also be made of steel without an inner lining.

It is also advantageous if means are provided for heating the gas introduced into a space of the roller chamber to a desired temperature.

In one design of the roller chamber, it is provided that it has an essentially rectangular cross-sectional contour, and a guide channel for the metal strip is joined with the first space in the direction of conveyance of the metal strip.

As an alternative to this, in one embodiment of the roller chamber, it has an essentially rectangular cross-sectional contour, which forms one of the spaces, which is joined with a second space that is formed by a guide channel for the metal strip.

The proposal of the invention makes it possible, especially under abnormal operating conditions, such as in the event of a power loss or an accident, or during the starting up or shutting down of the hot dip coating installation, to maintain more favorable operating conditions.

The present invention thus provides a procedure and design with which an important contribution is made to the operation of a hot dip coating installation with a high degree of operational reliability.

To prevent any mixing of hydrogen with penetrating atmospheric oxygen, especially in case of power loss or in the event of an accident and thus escape of coating metal from the coating tank, the area of the bottom entry into the coating tank, i.e., the area directly below the coating tank and the corresponding area of the roller chamber (the last space of the roller chamber in the direction of conveyance of the metal strip) is operated with a different atmosphere than the rest of the furnace region. The hydrogen concentration is less than 5 vol. % here.

Specific embodiments of the invention are illustrated in the drawings.

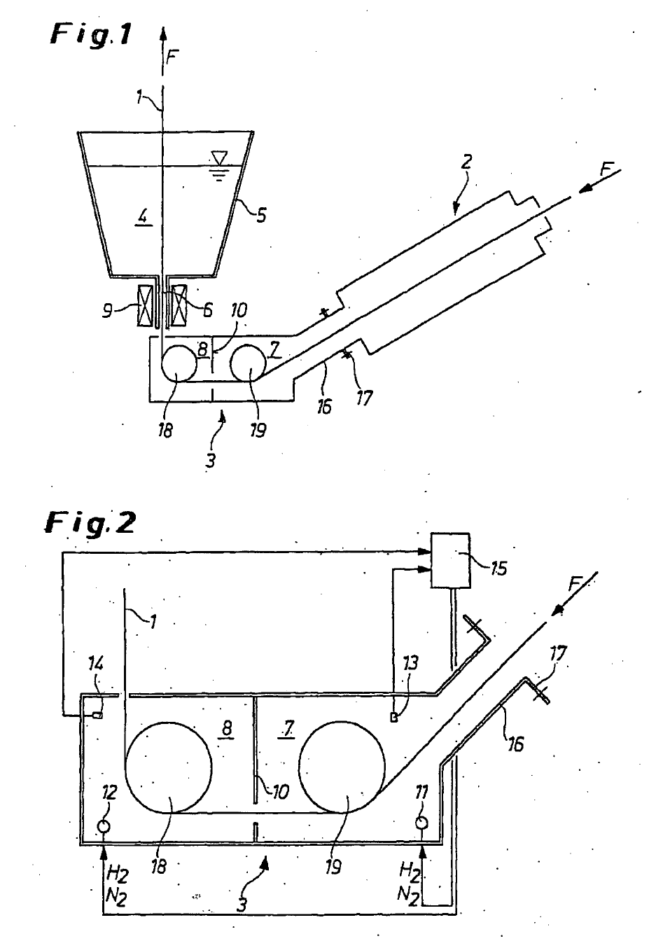

FIG. 1 is a schematic drawing of a hot dip coating installation in a side view.

FIG. 2 shows a first embodiment of the roller chamber of the hot dip coating installation of the invention in a side view.

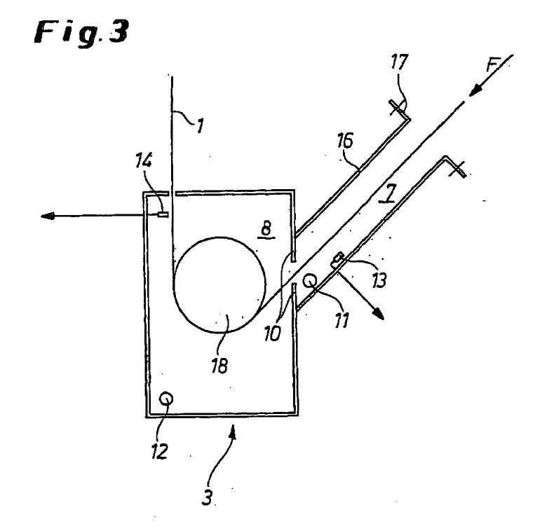

FIG. 3 shows a second embodiment of the roller chamber of the hot dip coating installation of the invention in a side view.

FIG. 1 shows a hot dip coating installation that operates by the so-called CVGL process (continuous vertical galvanizing line process). A tank 5 contains molten coating metal 4. The bottom of the tank 5 has an opening 6, through which a metal strip 1 passes vertically upward to be coated with coating metal 4. To prevent the liquid coating metal from flowing out through the opening 6 at the bottom, an electromagnetic inductor 9 is provided, which effects closure of the opening 6 in a well-known way.

The metal strip 1 to be coated, which moves in direction of conveyance F, first enters a furnace 2, in which—as explained above—it is brought to the desired process temperature. The furnace 2 is followed by a roller chamber 3, with which it is connected by a connecting flange 17. The purpose of the roller chamber 3 is to deflect the preheated strip 1 from the direction in which it enters the roller chamber into the vertical direction and to introduce the strip 1 precisely into the opening 6 in the tank 5. Two rollers 18 and 19 are provided for this purpose, but, as FIG. 3 shows, one roller can also be sufficient.

As is most clearly shown in FIGS. 2 and 3, the roller chamber 3 in this embodiment consists of two spaces 7 and 8 that are separated from each other by a partition 10.

The roller chamber 3 according to FIG. 2 has a rectangular cross-sectional contour (in a side view), and both spaces 7, 8 are essentially rectangular. The first space 7 in the direction of conveyance F is joined on the right with a guide channel 16 for the metal strip 1. FIG. 3 shows that one of the spaces 7 can also be formed solely by this guide channel 16.

The essential feature is that the two spaces are designed in such a way that different gas atmospheres can be maintained in them.

To this end, each space is provided with a gas supply line 11 or 12, through which a gas or gas mixture can be fed into the space 7, 8. The gas may be nitrogen N₂ or hydrogen H₂ or a mixture thereof.

Gas sensors 13, 14 in each space 7, 8 determine the parameters of the gas atmosphere. For example, the concentration of hydrogen gas H₂ can be measured with the sensors 13, 14. The measured values are fed to an automatic control unit 15 in the illustrated embodiment (see FIG. 2). The automatic control unit 15 controls the supply of gas or gas mixture through the gas supply lines 11, 12, so that the desired gas compositions or gas concentrations are present in each of the spaces 7, 8.

It is especially desirable for the hydrogen concentration to be greater than 5 vol. % (in the furnace 2 and) in the first space 7 and for the hydrogen concentration to be less than 5 vol. % in the second space 8.

The gas atmosphere in the roller chamber 3 is thus separated from the gas atmosphere in the furnace 2. In addition, the roller chamber 3 is divided into different gas spaces, which are connected with each other by openings for the passage of the steel strip, i.e., the roller chamber is fitted with partitions 10, which divide it into at least two gas spaces.

Different concentrations of nitrogen and hydrogen are fed into the gas spaces, as explained above, through two or more supply points for the protective gas (at least one for each gas space).

The atmosphere is monitored by at least one measurement per gas space, and the desired concentrations are adjusted in a closed-loop control system. In this regard, in the gas zone directly below the coating tank 5, nitrogen is added without oxygen. The gas flow within the roller chamber is directed towards the point of entry of the furnace when the installation is in a state of operation. In the event of drainage of coating metal 4 from the tank 5, the escape of hydrogen-enriched furnace atmosphere is prevented by the nitrogen lock which has just been described.

The inside of the roller chamber 3 is lined with ceramic. The roller chamber 3 consists of a steel housing with a ceramic inner lining, which forms the different gas spaces. The protective gas that is fed into the roller chamber 3 is heated and thus serves to maintain the internal temperature of the roller chamber.

The lining provides an insulating effect (reduced heat conduction to the outside). In addition, it is made in such a way that it is resistant to molten metals, e.g., zinc or aluminum or their alloys, in the event of an accident and the associated risk of intrusion of molten metal into the roller chamber.

### LIST OF REFERENCE SYMBOLS

1 metal strip
2 furnace
3 roller chamber
4 molten coated metal
5 tank
6 opening at the bottom of the tank
7 first space
8 second space
9 electromagnetic inductor
10 partition
11 gas supply line
12 gas supply line
13 gas sensor
14 gas sensor
15 automatic control unit
16 guide channel
17 connecting flange
F direction of conveyance
H₂ hydrogen
N₂ nitrogen

1. A method for hot dip coating a metal strip (1), especially a steel strip, in which the metal strip (1) is fed through a furnace (2) and a roller chamber (3), which follows the furnace (2) in the direction of conveyance (F) of the metal strip (1), and into a tank (5) that holds the molten coating metal (4) through an opening (6) in the bottom of the tank (5), where an electromagnetic field is generated near the bottom of the tank (5) to retain the coating metal (4) in the tank (5), wherein different gas atmospheres are maintained in at least two separated spaces (7, 8) of the roller chamber (3).

2. A method in accordance with claim 1, wherein the gas atmosphere of a space (8) of the roller chamber (3) that is downstream in the direction of conveyance (F) of the metal strip (1) has a lower hydrogen concentration than the gas atmosphere of another space (7) of the roller chamber (3) that is upstream of this space (8).

3. A method in accordance with claim 1 or claim 2, wherein the first space (7) of the roller chamber (3) in the direction of conveyance (F) of the metal strip (1) has a gas atmosphere with a hydrogen concentration of greater than 5 vol. %.

4. A method in accordance with any of claims 1 to 3, wherein the last space (8) of the roller chamber (3) in the direction of conveyance (F) of the metal strip (1) has a gas atmosphere with a hydrogen concentration of less than 5 vol. %.

5. A method in accordance with any of claims 1 to 4, wherein, besides hydrogen, the gas atmospheres in the spaces (7, 8) of the roller chamber (3) contain essentially only nitrogen.

6. A method in accordance with any of claims 1 to 5, wherein the desired compositions of the gas atmospheres in the spaces (7, 8) of the roller chamber (3) are maintained by a closed-loop control system.

7. A device for hot dip coating a metal strip (1), especially a steel strip, with a furnace (2), a roller chamber (3) downstream of the furnace (2) in the direction of conveyance (F) of the metal strip (1), and a tank (5) for holding the molten coating metal (4), where the bottom of the tank (5) has an opening (6), through which the metal strip (1) is fed into the tank (5), and where an electromagnetic inductor (9) for retaining the coating metal (4) in the tank (5) is located near the bottom of the tank (5), especially for carrying out the method in accordance with any of claims 1 to 6, wherein at least one partition (10) is present in the roller chamber (3), so that the roller chamber (3) is divided into at least two spaces (7, 8).

8. A device in accordance with claim 7, wherein each space (7, 8) of the roller chamber (3) has at least one gas supply line (11, 12), through which gas of a well-defined type and/or composition can be introduced into the space (7, 8).

9. A device in accordance with claim 7 or claim 8, wherein each space (7, 8) of the roller chamber (3) has at least one gas sensor (13, 14), with which the type and/or composition and/or concentration of a gas in the space (7, 8) can be determined.

10. A device in accordance with any of claims 7 to 9, wherein an automatic control unit (15) is present, with which the gas composition and/or the concentration of a gas can be maintained at the desired values in at least one of the spaces (7, 8) and preferably in all of the spaces (7, 8).

11. A device in accordance with any of claims 7 to 10, wherein the roller chamber (3) is provided with a ceramic inner lining.

12. A device in accordance with any of claims 7 to 11, wherein the roller chamber (3) has a steel housing.

13. A device in accordance with any of claims 7 to 12, wherein means are provided for heating the gas introduced into a space (7, 8) of the roller chamber (3) to a desired temperature.

14. A device in accordance with any of claims 7 to 13, wherein the roller chamber (3) has an essentially rectangular cross-sectional contour, and a guide channel (16) for the metal strip (1) is joined with the first space (7) in the direction of conveyance (F) of the metal strip (1).

15. A device in accordance with any of claims 7 to 13, wherein the roller chamber (3) has an essentially rectangular cross-sectional contour, which forms one of the spaces (8), which is joined with a second space (7) that is formed by a guide channel (16) for the metal strip (1).
